(19) United States
(12) Patent Application Publication
(10) Pub. No.: US 2012/0229457 A1
(43) Pub. Date: Sep. 13, 2012

(54) DISPLAY DEVICE

(75) Inventor: Goro Hamagishi, Osaka (JP)

(73) Assignee: Sony Corporation, Tokyo (JP)

(21) Appl. No.: 13/412,187

(22) Filed: Mar. 5, 2012

(30) Foreign Application Priority Data
Mar. 11, 2011 (JP) 2011-054453

(51) Int. Cl. G06T 15/00

(52) U.S. Cl. 345/419

(57) ABSTRACT

There is provided a display device excellent in resolution balance when a plurality of perspective pictures is used for stereoscopic display. The display device includes a display section including a plurality of sub-pixels, and displaying a plurality of perspective pictures in a screen, and an optical separation element optically separating the perspective pictures displayed on the display section. The sub-pixels are each with, in a planar view, a size in a long-side direction being less than three times a size in a short-side direction.

### BACKGROUND

The present disclosure relates to a display device capable of stereoscopic display using the technology of parallax barrier or lenticular lens, for example.

### SUMMARY

A display device implementing stereoscopic display, i.e., stereoscopic display device, has been recently receiving attention. With stereoscopic display, two pictures having a parallax (viewed from different viewpoints) are displayed respectively for right and left eyes of an observer. The observer views the left-eye picture by his or her left eye and the right-eye picture by his or her right eye, thereby perceiving the pictures with the three-dimensional (3D) appearance with depth. There is also a display device capable of providing observers with, by displaying three or more pictures having a parallax, stereoscopic pictures looking more natural than those previously provided.

Such a stereoscopic display device is mainly of two types, i.e., a type using glasses specifically designed therefor, and a type not using such glasses. However, the glasses specifically designed for the display device as such are annoying to the observers, and thus the type not using such glasses is desirable, i.e., the type implementing stereoscopic viewing directly by the observers' eyes. Such a stereoscopic display device realizing stereoscopic viewing directly by the observers' eyes popularly includes the one using the technology of parallax barrier or lenticular, for example. With the stereoscopic display device using the technology as such, a plurality of pictures having a parallax (parallax pictures) are displayed all at once to make those look different depending on the relative positional relationship (angle) between the display device and the viewpoint of an observer. However, when such a stereoscopic display device displays a plurality of pictures observed from a plurality of viewpoints, the substantial resolution of the resulting pictures is to be of a lower level, i.e., the resolution of the display device itself such as CRT (Cathode Ray Tube) and liquid crystal display device is divided by the number of viewpoints, and this causes an issue of reduced image quality.

In order to solve this issue, various studies have been made so far. As an example, Japanese Unexamined Patent Application Publication No. 2009-104105 describes a method of equivalently improving the resolution by, using the technology of parallax barrier, time-sharing display through time-sharing switching of state for barriers between passing-through and blocking.

The issue here is that, when the parallax barriers are extended in the perpendicular direction of the screen, the method indeed improves the resolution in the horizontal direction of the screen but has a difficulty in improving the resolution in the perpendicular direction of the screen. In consideration thereof, for improving the balance of resolution between the horizontal and perpendicular directions of the screen (resolution balance), developed is the technology of step barrier. With the step barrier technology, parallax barriers are so set that their apertures are arranged (or extended) in a diagonal direction, or lenticular lenses are so set that the axis direction thereof is the diagonal direction of the screen. In the screen, sub-pixels in a plurality of colors, e.g., R (red), G (green), and B (blue), are adjacently arranged in the diagonal direction, and these sub-pixels of RGB configure a unit pixel.

With the step barrier technology as described above, however, like a display pattern 110 of FIG. 10, for example, sub-pixels R1, G1, and B1 configuring a unit pixel 104 are arranged in the diagonal direction in a certain perspective picture. This increases the size of the planar region allocated to the unit pixel 104 on the display screen, thereby possibly interfering with high-definition picture display. Moreover, with the fewer number of viewpoints (e.g., about two to four) expected to a display device for use in a portable terminal unit such as mobile phone, even if the step barrier technology is used, the resulting resolution balance is not good enough. Note that, even with the time-sharing drive as in Japanese Unexamined Patent Application Publication No. 2009-104105 above, the above-described issue with the step barrier technology still possibly remains unsolved.

It is thus desirable to provide a display device excellent in resolution balance when a plurality of perspective pictures are used for stereoscopic display.

A display device according to an embodiment of the present disclosure includes a display section, and an optical separation element. The display section includes a plurality of sub-pixels, and displays a plurality of perspective pictures in a screen. The optical separation element optically separates the perspective pictures displayed on the display section. Herein, the sub-pixels are each with, in a planar view, a size in a long-side direction being less than three times a size in a short-side direction.

With the display device according to the embodiment of the present disclosure, a plurality of perspective pictures displayed on the display section are optically separated by the optical separation element to allow stereoscopic viewing at a plurality of viewpoints. Herein, since the sub-pixels are each with, in a planar view, the size in the long-side direction being less than three times the size in the short-side direction, this accordingly prevents the resolution from degrading differently between the horizontal and perpendicular directions of the screen.

A display device according to an embodiment of the present disclosure includes a display section, and an optical separation element. The display section includes a plurality of sub-pixels, and displays a plurality of perspective pictures in a screen. The optical separation element optically separates the perspective pictures displayed on the display section. Herein, the sub-pixels are arranged to have an arrangement pitch in a long-side direction less than three times an arrangement pitch in a short-side direction.

With the display device according to the embodiment of the present disclosure, a plurality of perspective pictures displayed on the display section are optically separated by the optical separation element to allow stereoscopic viewing at a plurality of viewpoints. Herein, since the sub-pixels are arranged to have the arrangement pitch in the long-side direction less than three times the arrangement pitch in the short-side direction, this accordingly prevents the resolution from degrading differently between the horizontal and perpendicular directions of the screen.

With the display device according to the embodiment of the present disclosure, the balance of resolution (resolution balance) is improved between the horizontal and perpendicular directions of the screen. This accordingly leads to the display performance almost the same in level for both a so-called Portrait mode and a Landscape mode.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view of a stereoscopic display device in a first embodiment of the present disclosure, showing the configuration thereof.

FIG. 2 is a plan view of a liquid crystal display panel in the stereoscopic display device in the first embodiment, showing the arrangement of sub pixels therein.

FIG. 3 is a plan view of an exemplary display pattern to be displayed on the liquid crystal display panel of FIG. 1 or others.

FIGS. 4A to 4D are conceptual diagrams respectively showing original images of four perspective pictures to be synthesized to form the display pattern of FIG. 3.

FIG. 5 is a plan view of an exemplary bather pattern to be formed by a parallax barrier of FIG. 1 or others.

FIG. 6 is an illustration diagram schematically showing how stereoscopic viewing is done.

FIG. 7 is a plan view of an exemplary display pattern to be displayed on a liquid crystal display panel in a stereoscopic display device in a second embodiment.

FIG. 8 is a plan view of a liquid crystal display panel in a stereoscopic display device in a third embodiment, showing the arrangement of sub-pixels therein.

FIG. 9 is a plan view of an exemplary display pattern to be displayed on the liquid crystal display panel of FIG. 8.

FIG. 10 is a plan view of an exemplary display pattern as a first comparative example.

FIG. 11 is a plan view of an exemplary display pattern as a second comparative example.

### DETAILED DESCRIPTION OF THE PREFERRED EMBODIMENTS

In the below, embodiments of the present disclosure are described in detail by referring to the accompanying drawings.

### First Embodiment

### (Configuration of Stereoscopic Display Device)

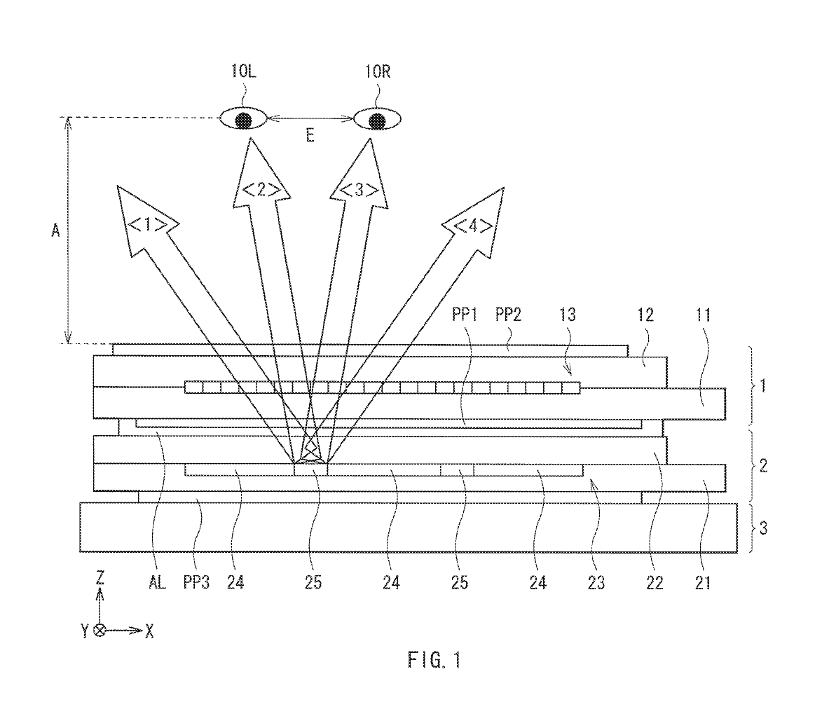

FIG. 1 is a schematic cross-sectional view of a stereoscopic display device in a first embodiment of the present disclosure, showing the configuration thereof in its entirety. This stereoscopic display device is configured to include, as shown in FIG. 1, a liquid crystal display panel 1, a parallax barrier 2, and a backlight 3 in this order from the side of an observer. The liquid crystal display panel 1 and the parallax barrier 2 are fixed to each other by an adhesive layer AL made of ultraviolet curable resin, for example.

The liquid crystal display panel 1 is a transmissive liquid crystal display panel including a plurality of sub-pixels (will be described later), which are arranged two-dimensionally. In the liquid crystal display panel 1 as such, a liquid crystal layer 13 is sealed in between a pair of transparent substrates 11 and 12 opposed to each other. The transparent substrates 11 and 12 are respectively provided on their inner surfaces with a pixel electrode and an opposing electrode so as to sandwich the liquid crystal layer 13 therebetween (neither electrode is shown). In other words, either the pixel electrode or the opposing electrode is disposed on the inner surface of the transparent substrate 11, and the remaining electrode is disposed on the inner surface of the transparent substrate 12. The opposing electrode is provided for shared use by all of the sub-pixels, and the pixel electrode is provided separately to each of the sub-pixels. The transparent substrate 11 or 12 is provided on the surface with a color filter in three colors of R (red), G (green), and B (blue) for use with color display. This color filter is provided to specifically each of the sub-pixels. Light coming from the backlight 3 passes through such three-color filters after entering the liquid crystal display panel 1 via the parallax barrier 2, and is emitted in colors of red, green, and blue from the liquid crystal display panel 1. Note here that the outer surfaces of the transparent substrates 11 and 12, i.e., the surfaces opposite to the liquid crystal layer 13, may be provided with polarizer plates PP1 and PP2 as appropriate.

The backlight 3 is provided with a light source such as light-emitting diode (LED), and a light-guiding plate for achieving almost-uniform plane emission through diffusion of the light coming from the light source (neither is shown), for example. Note here that, on the emission side of the backlight 3, a polarizer plate PP3 may be provided as appropriate.

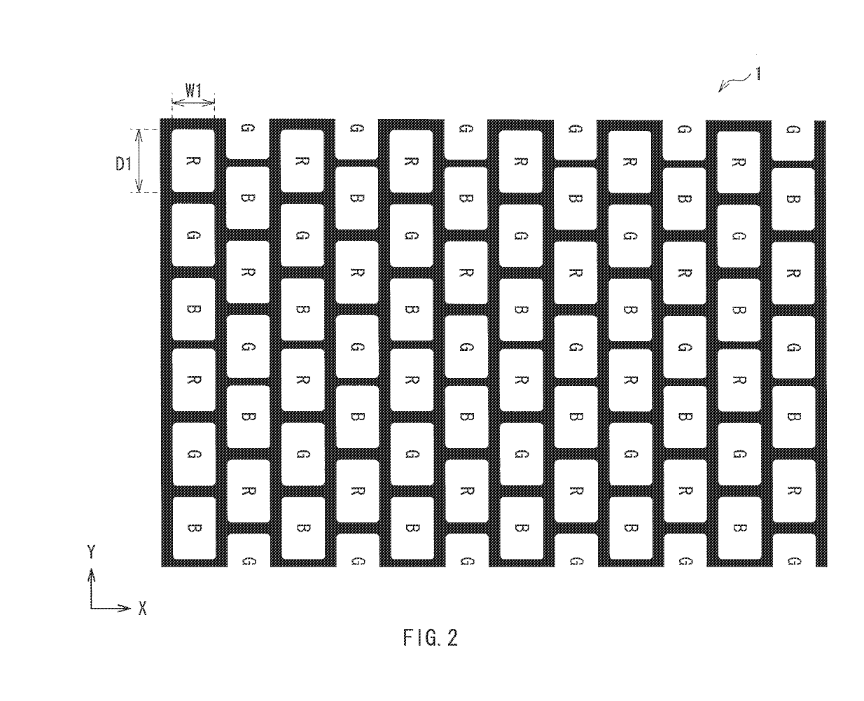

FIG. 2 shows an exemplary arrangement of the sub-pixels on the liquid crystal display panel 1. As shown in FIG. 2, the liquid crystal display panel 1 includes a plurality of the sub-pixels R, G, and B two-dimensionally arranged. The pattern of the arrangements of the sub-pixels R, G, and B shown in FIG. 2 is the one so-called delta arrangement. To be specific, the sub-pixels R, G, and B are so arranged that the three colors appear periodically, i.e., the three colors are repeatedly in order of R, G, and B, in each row in the vertical direction (Y-axis direction) of the screen, and also in each row in the diagonal direction of the screen. The rows of the sub-pixels R, G, and B along the Y-axis direction, i.e., the vertical-direction sub-pixel rows, and the rows of the sub-pixels R, G, and B along the diagonal direction of the screen, i.e., the diagonal-direction sub-pixel rows, are each desirably fixed in arrangement pitch in the screen. With such arrangements of the sub-pixels, the sub-pixels adjacent to each other are different in color in every direction of the screen.

The sub-pixels R, G, and B are each with, in a planar view, the size in the long-side direction being less than three times the size in the short-side direction. In FIG. 2, the ratio between the sizes in the two directions is 4:3, i.e., between the size (hereinafter, referred to as “length”) D1 in the Y-axis direction (in the long-side direction) and the size (hereinafter, referred to as “width”) W1 in the X-axis direction (in the short-side direction). As for the sub-pixels previously used, the ratio between the length and width is 3:1, and compared with a liquid crystal display panel using such sub-pixels, the liquid crystal display panel 1 of this embodiment offers a better balance in terms of degradation of resolution between the vertical direction of the screen and the horizontal direction thereof. This will be described in detail later. Note that the sub-pixels in the screen are preferably all substantially the same in size.

With the pixel configuration as such, the liquid crystal display panel 1 performs image display two-dimensionally through modulation of light coming from the backlight 3 on a sub-pixel basis.

Herein, in order to realize stereoscopic viewing, there is expected to provide different perspective pictures to left and right eyes 10L and 10R of an observer. Therefore, there is expected to provide at least two perspective pictures, i.e., a perspective picture for the right eye, and a perspective picture for the left eye. When three or more perspective pictures are in use, multiple stereoscopic viewing is realized. In this embodiment, described is a case of forming four perspective pictures (first to fourth perspective pictures) respectively denoted by <1> to <4> in FIG. 1, i.e., the number of viewpoints is four, and making an observation using two of the perspective pictures. Herein, FIG. 1 shows that the third perspective picture enters the right eye 10R as the right-eye picture, and the second perspective picture enters the left eye 10L as the left-eye picture.

The liquid crystal display panel 1 is so configured as to display the spatially-divided four perspective pictures after synthesis thereof to fit in a screen. The spatially-divided four perspective pictures are each a row of vertical-direction sub-pixels, and are periodically displayed on four rows basis in the horizontal direction of the screen.

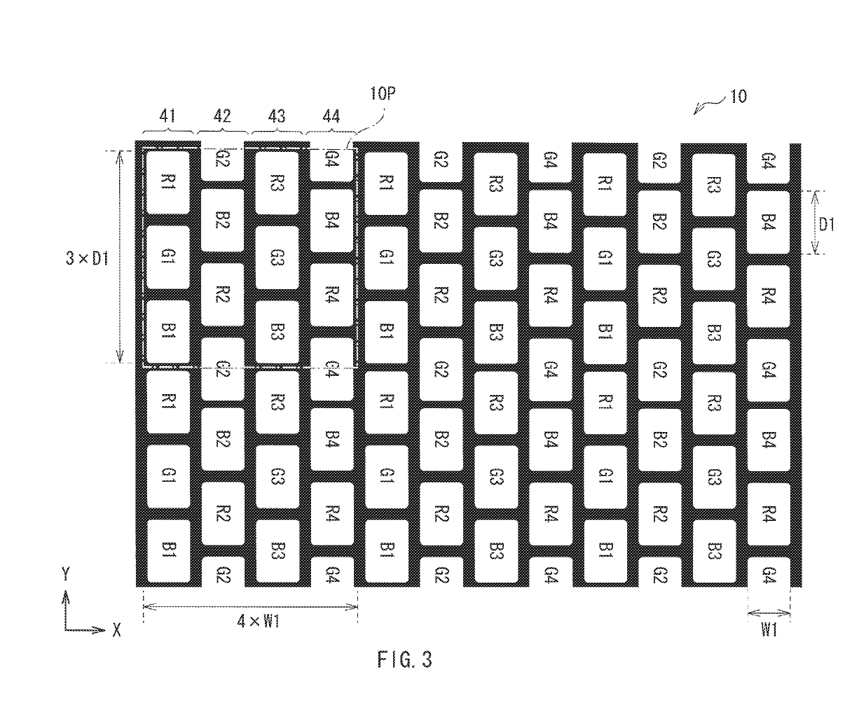

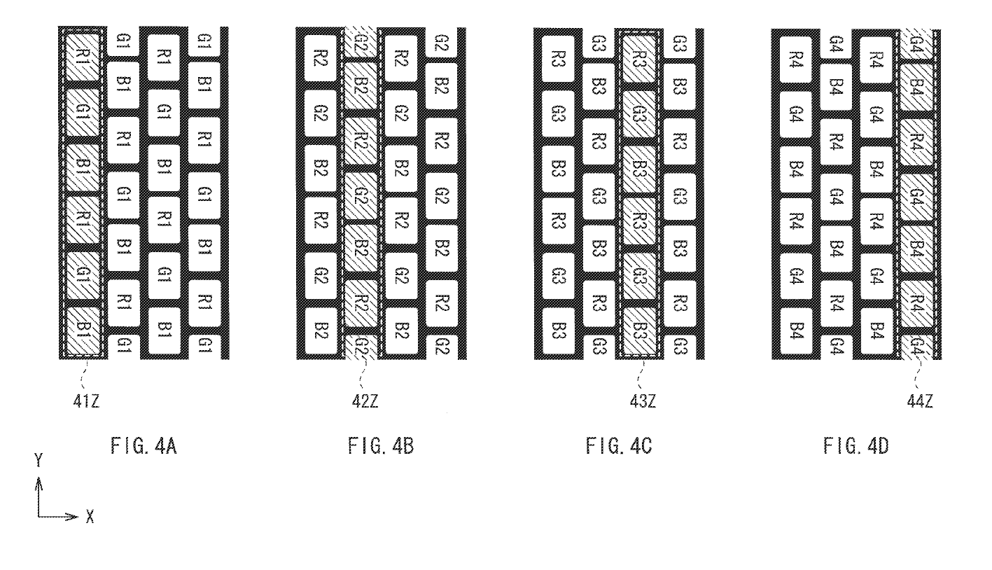

FIG. 3 shows a display pattern 10 as exemplary four perspective pictures displayed through synthesis to fit in a screen. In the display pattern 10, first to fourth sub-pixel rows 41 to 44 are each extended in the vertical direction of the screen, and are periodically arranged in order in the horizontal direction of the screen. The first sub-pixel row 41 includes a plurality of sub-pixels respectively denoted by R1, G1, and B1, which are arranged in the vertical direction of the screen. The first sub-pixel row 41 displays the first perspective picture. Similarly, the second sub-pixel row 42 includes a plurality of sub-pixels respectively denoted by R2, G2, and B2, which are arranged in the vertical direction of the screen. The second sub-pixel row 42 displays the second perspective picture. The third sub-pixel row 43 includes a plurality of sub-pixels respectively denoted by R3, G3, and B3, which are arranged in the vertical direction of the screen. The third sub-pixel row 43 displays the third perspective picture. The fourth sub-pixel row 44 includes a plurality of sub-pixels respectively denoted by R4, G4, and B4, which are arranged in the vertical direction of the screen. The fourth sub-pixel row 44 displays the fourth perspective picture. More in detail, the first to fourth sub-pixel rows 41 to 44 each display a portion cut out from a two-dimensional (2D) image being an original image of the corresponding perspective picture, i.e., a portion based on which viewpoint position. In other words, the first sub-pixel row 41 displays a partial image 41Z of the 2D image corresponding to the first perspective picture of FIG. 4A. Similarly, the second to fourth sub-pixel rows 42 to 44 display partial images 42Z, 43Z, and 44Z of the 2D images corresponding to the second to fourth perspective pictures of FIGS. 4B, 4C, and 4D, respectively.

Herein, how the sampling is performed from the original images (2D images) is not specifically restrictive. In other words, unit pixels displaying the first to fourth perspective pictures are each configured by three sub-pixels of R, G, and B, which are arbitrarily selected from the first to fourth sub-pixel rows 41 to 44.

The parallax barrier 2 includes a liquid crystal layer 23 sealed in between a pair of opposing transparent substrates 21 and 22 as shown in FIG. 1, for example. The parallax barrier 2 allows light to selectively pass therethrough based on the alignment state of liquid crystal molecules in the liquid crystal layer 23. In other words, in the parallax barrier 2, during stereoscopic display, light pass-through sections 25 and light block sections 24 are at their predetermined positions. The light pass-through sections 25 allow light from the backlight 3 to pass therethrough, and the light block sections 24 allow the light to be blocked. With such a configuration, the parallax barrier 2 forms a barrier pattern for optically separating the first to fourth perspective pictures displayed on the liquid crystal display panel 1 to achieve stereoscopic viewing at four viewpoints.

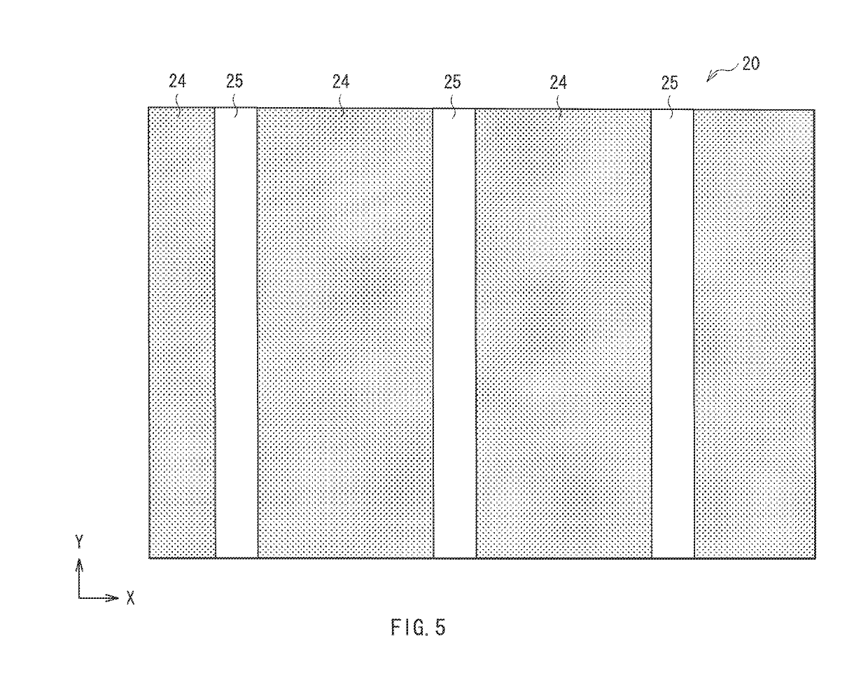

FIG. 5 shows an exemplary barrier pattern 20 to be formed by the liquid crystal layer 23 of the parallax barrier 2. In the barrier pattern 20, the light pass-through sections 25 are so disposed and shaped as to allow the right and left eyes 10R and 10L of an observer (FIG. 1) to be provided with light of different perspective pictures when the stereoscopic display device is viewed by the observer from a predetermined direction at a predetermined position. In FIG. 5, the light pass-through sections 25 are each stripe-shaped extending in the vertical direction of the screen corresponding to the first to fourth sub-pixel rows 41 to 44 of FIG. 3. Accordingly, the light block sections 24 are also each stripe-shaped extending in the vertical direction of the screen.

In the parallax barrier 2, the transparent substrates 21 and 22 are respectively provided on the inner surfaces with a pattern electrode and an opposing electrode so as to sandwich the liquid crystal layer 23 therebetween (neither electrode is shown). In other words, either the pattern electrode or the opposing electrode is disposed on the inner surface of the transparent substrate 21, and the remaining electrode is disposed on the inner surface of the transparent substrate 22. The opposing electrode is so provided as to entirely cover the liquid crystal layer 23 at least in an effective screen region. On the other hand, the pattern electrode is divided into a plurality of pieces to be periodically disposed in the horizontal direction of the screen, i.e., one for every four sub-pixel rows. The divided pieces of the pattern electrode are each stripe-shaped similarly to the light pass-through sections 25.

With the parallax barrier 2 in such a configuration, when a voltage is applied between the stripe-shaped pattern electrodes and the opposing electrode, for example, the light pass-through sections 25 each stripe-shaped correspondingly to the shape of the pattern electrodes are formed at fixed intervals. Specifically, when the liquid crystal layer 23 is configured of a twisted nematic liquid crystal that is in white display when no voltage is applied, i.e., in the so-called normally white mode, for example, liquid crystal molecules included in the twisted nematic liquid crystal in a region where the pattern electrodes are formed are aligned in the perpendicular direction so that the region serves as the light block sections 24. Note that the liquid crystal mode is not specifically restrictive, and the Electrically Controlled Birefringence mode will also do, for example. Other options may include the Vertical Aligned (VA) mode, and the In-Plane Switching (IPS) mode that lead to black display when no voltage is applied, i.e., display in the normally black mode, as long as these modes allow white display in 2D images by arbitrary changes of the electrode configuration, for example. As such, the parallax barrier 2 functions well to optically separate the four perspective pictures to make those available for stereoscopic viewing at four viewpoints. As a result, the observer perceives the pictures displayed on the liquid crystal display panel 1 as 3D pictures.

On the other hand, when no voltage is applied between the pattern electrodes and the opposing electrode, the liquid crystal layer 23 is entirely in the light-pass state. If this is the case, the parallax barrier 2 does not function to optically separate the four perspective pictures. As a result, when no voltage is applied between the pattern electrodes and the opposing electrode, the observer perceives not three-dimensionally but two-dimensionally the pictures displayed on the liquid crystal display panel 1.

### (Operation of Stereoscopic Display Device)

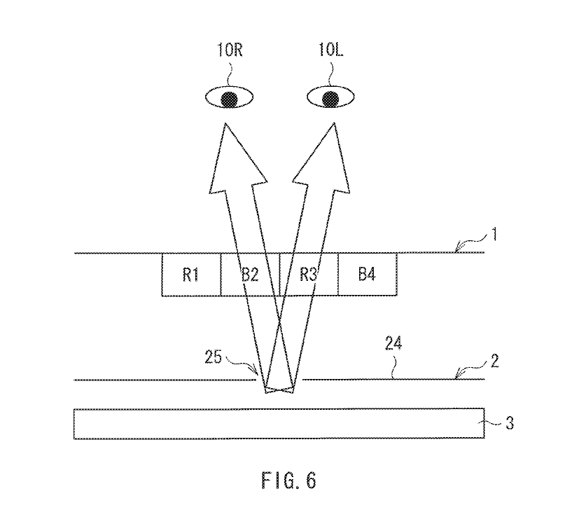

With this stereoscopic display device, every perspective picture is spatially divided before display in a screen of the liquid crystal display panel 1. To be specific, as the display pattern 10 of FIG. 3, for example, the first to fourth perspective pictures are each allocated to any of the first to fourth sub-pixel rows 41 to 44 for display. Such display is observed via the barrier pattern 20 (FIG. 5) formed by the parallax barrier 2. With the parallax barrier 2, light coming from the backlight 3 is selectively passed therethrough so that the four perspective pictures displayed on the liquid crystal display panel 1 are optically separated to make those available for stereoscopic viewing at four viewpoints. Specifically, as exemplarily shown in FIG. 6, the right eye 10R of the observer acknowledges only the light coming from the sub-pixels R3, G3, and B3 forming the third perspective picture. On the other hand, the left eye 10L of the observer acknowledges only the light coming from the sub-pixels R2, G2, and B2 forming the second perspective picture. As such, the observer perceives a 3D image based on the second and third perspective pictures. Note that FIG. 6 is a conceptual diagram showing the cross-sectional configuration orthogonal to the screen (XY plane) in a part of FIG. 3. In FIG. 6, exemplified is a case that the observer perceives a 3D image by observing the second perspective picture by his or her right eye 10R, and by observing the third perspective picture by his or her left eye 10L. This is not restrictive, and the 3D image is possibly observed by arbitrarily combining two of the first to fourth perspective pictures.

### Effect of First Embodiment

As such, according to the first embodiment, the first to fourth perspective pictures being the results of optical separation by the parallax barrier 2 are formed by displaying the first to fourth sub-pixel rows 41 to 44 plurally at predetermined intervals. These first to fourth sub-pixels rows 41 to 44 are each configured by sub-pixels R, G, and B, which are each with, in a planar view, the length D1 being less than three times the width W1 (D1<3×W1). This favorably prevents the resolution from degrading differently between the perpendicular and horizontal directions of the screen compared with a case of using the previous sub-pixels each with the length three times the width.

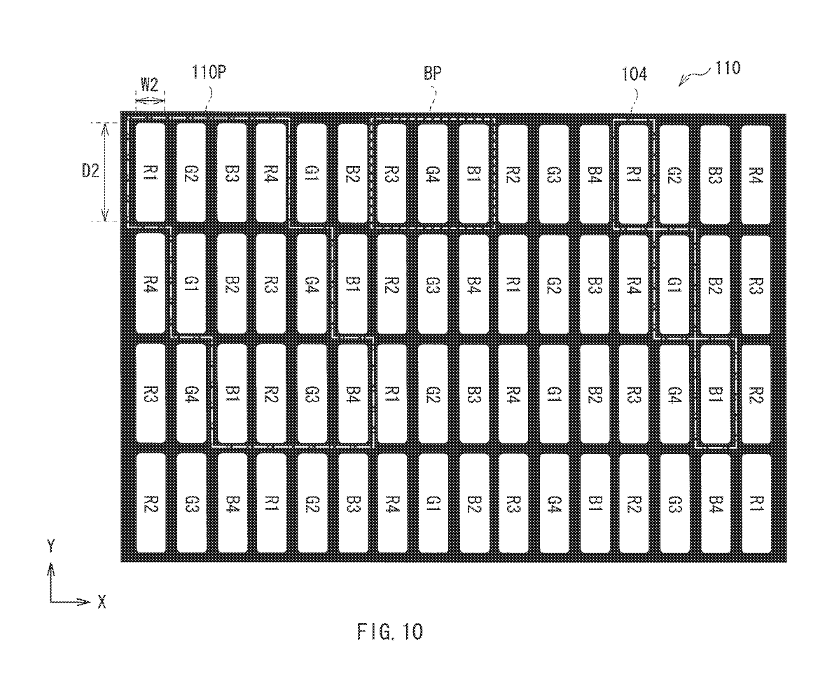

A detailed description is given about this by referring to FIG. 10 together with FIG. 3. The display pattern 110 of FIG. 10 as a comparative example includes a plurality of sub-pixels R, G, and B each with, in a planar view, the width of W2 and the length of D2 (=3×W2). Such a display pattern 110 shows four perspective pictures synthesized in a screen for display. A first perspective picture is displayed with the sub-pixels R1, G1, and B1 being a unit pixel, a second perspective picture is displayed with the sub-pixels R2, G2, and B2 being a unit pixel, a third perspective picture is displayed with the sub-pixels R3, G3, and B3 being a unit pixel, and a fourth perspective picture is displayed with the sub-pixels R4, G4, and B4 being a unit pixel. In FIG. 10, a region occupied by the three sub-pixels R, G, and B arranged in a row in the horizontal direction of the screen with the area taken up thereby is square, i.e., a region enlaced by broken lines, is hereinafter referred to as basic pixel region BP. This basic pixel region BP is equivalent to a unit pixel displaying a 2D image, and the area taken up thereby is represented by D2×(3×W2). On the other hand, a pixel region 110P including four unit pixels respectively displaying the first to fourth perspective pictures, i.e., a region enclosed by alternate long and short dashed lines, has the area represented by (3×D2)×(4×W2). In other words, with the display pattern 110, with the spatially-divided display, the resolution is reduced to ⅓ in the vertical direction of the screen, and to ¾ in the horizontal direction of the screen.

On the other hand, with the display pattern 10 (FIG. 3) of the first embodiment, a pixel region 10P including four unit pixels respectively displaying the first to fourth perspective pictures, i.e., a region enclosed by alternate long and short dashed lines, has the area represented by (3×D1)×(4×W1). Herein, with the aim of simplifying the comparison, the area taken up by each of the sub-pixels is equalized between the display pattern 10 (FIG. 3) and the display pattern 110 (FIG. 10), i.e., D1=D2/1.5, and W1=1.5×W2. If this is the case, the area of the pixel region 10P is (2×D2)×(6×W2), and this is twice the size the basic pixel region BP of FIG. 10 in both vertical and horizontal directions of the screen. In other words, with the display pattern 10, with the spatially-divided display, the resolution is reduced to ½ in both the vertical and horizontal directions of the screen so that the resolution balance is achieved. As such, according to the first embodiment, the balance of resolution is improved between the horizontal and vertical directions of the screen. This accordingly leads to the display performance almost the same in level for both a so-called Portrait mode and a Landscape mode.

### Second Embodiment

Described next is a stereoscopic display device as a second embodiment of the present disclosure. Note that any structure component substantially the same as that in the stereoscopic display device of the first embodiment above is provided with the same reference numeral, and is not described if appropriate.

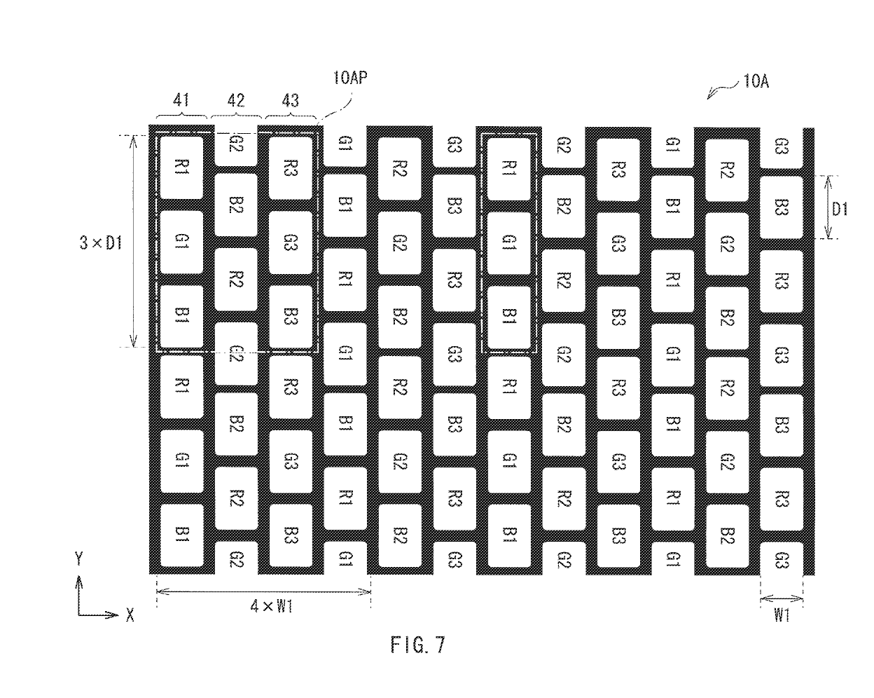

In the first embodiment above, described is the case of synthesizing four perspective pictures for display in a screen of the liquid crystal display panel 1. On the other hand, in this second embodiment, as shown in FIG. 7, described is a case of synthesizing three perspective pictures for display in a screen of the liquid crystal display panel 1. Note here that FIG. 7 shows a display pattern 10A as an example of synthesizing three perspective pictures for display in a screen of the liquid crystal display panel 1 in the stereoscopic display device of this embodiment. In the display pattern 10A, the first to third sub-pixel rows 41 to 43 are each extended in the vertical direction of the screen, and are periodically arranged in order in the horizontal direction of the screen. These first to third sub-pixel rows 41 to 43 respectively display the first to third perspective pictures. As a result, the stripe-shaped first to third perspective pictures extending in the vertical direction of the screen are periodically arranged in the horizontal direction of the screen. (Operation of Stereoscopic Display Device)

Also with the stereoscopic display device of this embodiment, stereoscopic viewing is possibly done similarly to that in the first embodiment described above. To be specific, the parallax barrier 2 similar to that in the first embodiment is used, and two of the first to third perspective pictures are respectively directed to enter the right and left eyes 10R and 10L of an observer so that the 3D image is to be observed.

### Effect of Second Embodiment

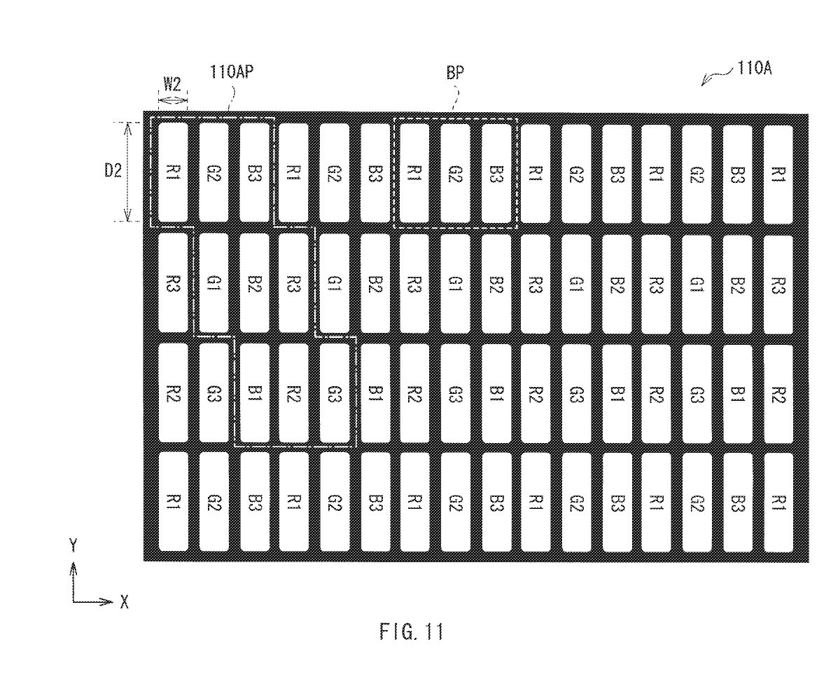

A detailed description is given by referring to FIG. 11 together with FIG. 7. The display pattern 110A of FIG. 11 as a comparative example includes a plurality of sub-pixels R, G, and B each with, in a planar view, the width of W2 and the length of D2 (=3×W2). Such a display pattern 110A shows three perspective pictures synthesized in a screen for display. A first perspective picture is displayed with the sub-pixels R1, G1, and B1 being a unit pixel, a second perspective picture is displayed with the sub-pixels R2, G2, and B2 being a unit pixel, and a third perspective picture is displayed with the sub-pixels R3, G3, and B3 being a unit pixel. In FIG. 11, the basic pixel region BP is equivalent to a unit pixel displaying a 2D image, and the area taken up thereby is represented by D2×(3×W2). On the other hand, a pixel region 110AP including three unit pixels respectively displaying the first to third perspective pictures, i.e., a region enclosed by alternate long and short dashed lines, has the area represented by (3×D2)×(3×W2). In other words, with the display pattern 110A, with the spatially-divided display, the resolution is reduced to ⅓ in the vertical direction of the screen, but the resolution in the horizontal direction of the screen remains the same.

On the other hand, with the display pattern 10A (FIG. 7) of the second embodiment, a pixel region 10AP including three unit pixels respectively displaying the first to third perspective pictures, i.e., a region enclosed by alternate long and short dashed lines, has the area represented by (3×D1)×(3×W1). Herein, assuming that D1=D2/1.5, and W1=1.5×W2, the area of the pixel region 10AP is (2×D2)×(4.5×W2), and this is twice the size the basic pixel region BP of FIG. 11 (D2×(3×W2)) in the vertical direction of the screen, and is 1.5 times the size the basic pixel region BP in the horizontal direction of the screen. In other words, with the display pattern 10A, with the spatially-divided display, the resolution is reduced to ½ in the vertical direction of the screen, and to ⅔ in the horizontal direction of the screen. As a result, compared with the display pattern 110A of FIG. 11, the resolution valance is relatively achieved. As such, also in the second embodiment, the balance of resolution is improved between the horizontal and perpendicular directions of the screen. This accordingly leads to the effects similar to those achieved in the first embodiment described above.

### Third Embodiment

Described next is a stereoscopic display device as a third embodiment of the present disclosure. Note that any structure component substantially the same as that in the stereoscopic display device of the first embodiment above is provided with the same reference numeral, and is not described if appropriate.

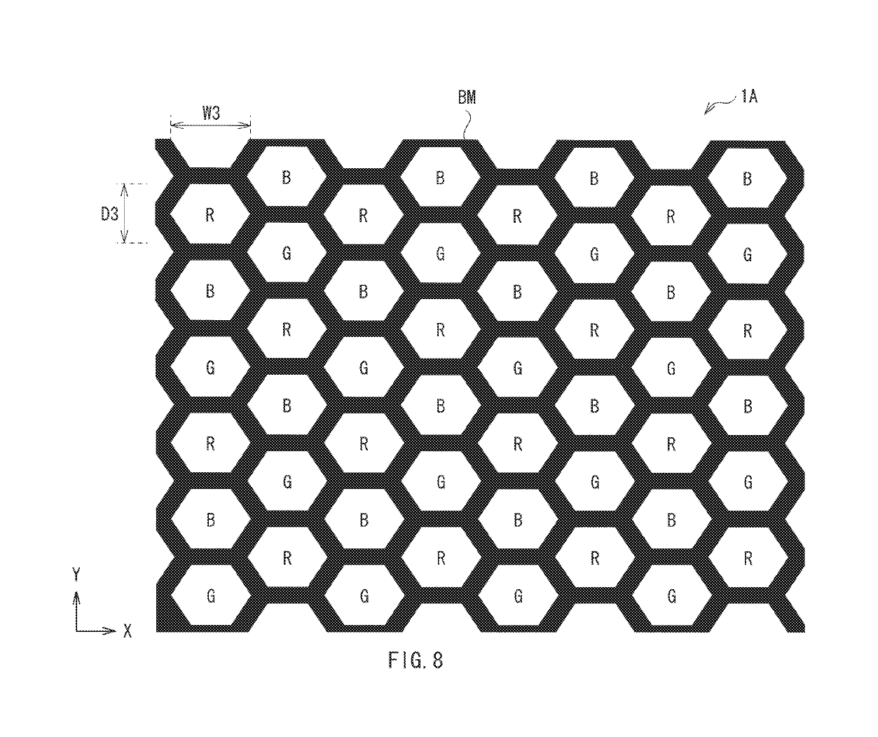

In the first and second embodiments described above, the sub-pixels R, G, and B in the liquid crystal display panel 1 each have the rectangular shape in a planar view with the long side thereof being along the vertical direction of the screen. On the other hand, as shown in FIG. 8, a liquid crystal display panel 1A in this third embodiment includes a plurality of sub-pixels R, G, and B each having the hexagonal shape in a planar view. As for the sub-pixels R, G, and B, a maximum length D3 is set to take a value smaller than a value three times a maximum width W3. Herein, FIG. 8 shows an exemplary sub-pixel arrangement in the liquid crystal display panel 1A.

### Effect of Third Embodiment

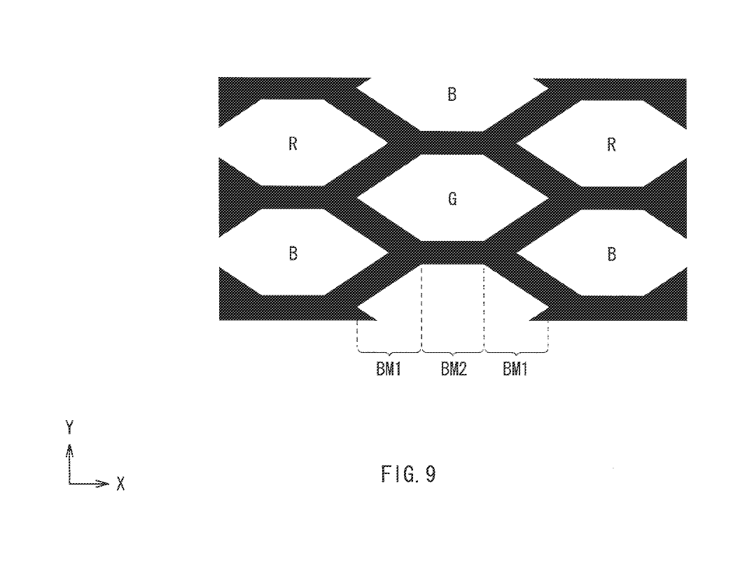

As shown in FIG. 8, in the liquid crystal display panel 1A, the sub-pixels R, G, and B each having the hexagonal shape in a planar view are in the delta arrangement. Accordingly, a no-display region (black matrix) sandwiched between the vertical-direction sub-pixel rows adjacent to each other in the horizontal direction (X-axis direction) of the screen includes a portion extending in the diagonal direction of the screen. Specifically, as shown in the enlarged view of FIG. 9, the black matrix BM includes portions BM1 sandwiched between the sub-pixels arranged in the diagonal direction of the screen, and a portion sandwiched BM2 between the sub-pixels arranged in the vertical direction of the screen. This accordingly prevents, compared with the liquid crystal display panel 1 of FIG. 2, any possible occurrence of moire in the vertical direction of the screen, which is resulted from the portion of the black matrix extending in the vertical direction of the screen. This is because of the reasons as below. That is, in the liquid crystal display panel 1 of FIG. 2, the black matrix is configured only by the portion extending in the vertical direction of the screen, and the portion extending in the horizontal direction of the screen. On the other hand, with the liquid crystal display panel 1A of FIG. 8, by including the portion extending in the diagonal direction, the percentage of the portion extending in the vertical direction of the screen is relatively reduced in the entire black matrix.

As such, also in this third embodiment, a 3D image is formed by using sub-pixels each with, in a planar view, the length D3 being less than three times the width W3 (D3<3×W3) so that the balance of resolution is improved between the horizontal and perpendicular directions of the screen. As such, the effects similar to those achieved in the first embodiment above are to be produced.

Moreover, in the third embodiment, the black matrix BM includes any portion extending in the diagonal direction of the screen, thereby being able to prevent also any possible occurrence of moire. Also in the embodiment, the space between the sub-pixels adjacent to each other in the diagonal direction of the screen, i.e., the size in the perpendicular direction of the screen, may be set to be smaller than the space between the sub-pixels adjacent to each other in the perpendicular direction of the screen, i.e., the size in the perpendicular direction of the screen. This is because this prevents the occurrence of moire more effectively.

While the present disclosure has been described in detail by referring to the embodiments, the present disclosure is not restrictive to the embodiments described above, and it is understood that numerous other modifications may be possibly devised. For example, in the embodiments described above, exemplified is the case of configuring a unit pixel in the 2D display section by sub-pixels in three colors of R (red), G (green), and B (blue). Alternatively, in the present disclosure, a unit pixel may be configured by sub-pixels in four colors or more, e.g., combinations of R (red), G (green), B (blue), and W (white), or Y (yellow).

Further, in the third embodiment above, the sub-pixels each have the hexagonal shape in a planar view. This is surely not restrictive, and the sub-pixels may each have the polygonal shape other than the square shape and the hexagon shape, or may each have the elliptic shape or the circular shape. Even if the sub-pixels each have the square shape, the sub-pixels may be so arranged that their contours extend in the diagonal direction to make the black matrixes include the portions extending in the diagonal direction of the screen, thereby being able to prevent the occurrence of moire.

Still further, in the embodiments described above, the arrangement of the 2D display section, the parallax barrier, and the backlight is in this order from the observer side. Alternatively, in the present disclosure, the arrangement may be in the order of the parallax barrier, the 2D display section, and the backlight from the observer side.

Still further, in the embodiments described above, exemplified is the color liquid crystal display using the backlight as the 2D display section. This is surely not restrictive, and a display using organic EL (electroluminescent) elements or a plasma display will also do, for example.

Still further, in the embodiments described above, the optical element is the parallax barrier or the liquid crystal lens. This is surely not restrictive, and even if the optical element is a lenticular lens including a plurality of cylindrical lenses arranged in a one-dimensional direction, for example, the resulting effects are to be similar to those achieved above.

The present disclosure is also possibly in the following configurations.

(1) A display device including

a display section including a plurality of sub-pixels, and displaying a plurality of perspective pictures in a screen, and

an optical separation element optically separating the perspective pictures displayed on the display section,

in which the sub pixels are each with, in a planar view, a size in a long-side direction being less than three times a size in a short-side direction.

(2) The display device according to (1), in which the sub-pixels adjacent to each other are different in color in every direction of the screen.

(3) The display device according to (1) or (2), in which the sub-pixels each have the hexagonal shape.

(4) The display device according to any one of (1) to (3), in which the sub-pixels are in a delta arrangement.

(5) The display device according to any one of (1) to (4), in which the optical separation element is

a parallax barrier including a plurality of light pass-through sections allowing light from the display section or light toward the display section to pass therethrough, and a plurality of light block sections allowing the light from the display section or the light toward the display section to be blocked.

(6) The display section according to (5), in which

the light pass-through sections and the light block sections in the parallax barrier are each stripe-shaped extending in the perpendicular direction of the screen.

(7) The display section according to any one of (1) to (6), in which the sub-pixels each have the square shape in a planar view, and a size ratio between the perpendicular and horizontal directions of the screen is 4:3.

(8) The display device according to any one of (1) to (7), in which

the sub-pixels are in the delta arrangement, and each have the hexagonal shape, and

a space between the sub-pixels adjacent to each other in the diagonal direction is smaller than a space between the sub-pixels adjacent to each other in the perpendicular direction of the screen.

(9) A display device including:

a display section including a plurality of sub-pixels, and displaying a plurality of perspective pictures in a screen; and

an optical separation element optically separating the perspective pictures displayed on the display section, wherein

the sub-pixels are arranged to have an arrangement pitch in a long-side direction less than three times an arrangement pitch in a short-side direction.

(10) The display device according to (9), wherein

the sub-pixels adjacent to each other are different in color in every direction of the screen.

(11) The display device according to (9) or (10), wherein

the sub-pixels each have a hexagonal shape.

(12) The display device according to any one of (9) to (11), wherein

the sub-pixels are in a delta arrangement.

(13) The display device according to any one of (9) to (12), wherein

the optical separation element is

a parallax barrier including a plurality of light pass-through sections allowing light from the display section or light toward the display section to pass therethrough, and a plurality of light block sections allowing the light from the display section or the light toward the display section to be blocked.

(14) The display device according to (13), wherein

the light pass-through sections and the light block sections in the parallax barrier are each stripe-shaped extending in a perpendicular direction of the screen.

(15) The display device according to any one of (9) to (14), wherein the sub-pixels each have a square shape in a planar view, and a size ratio between the perpendicular and horizontal directions of the screen is 4:3.

(16) The display device according to any one of (9) to (15), wherein

the sub-pixels are in a delta arrangement, and each have a hexagonal shape, and

a space between the sub-pixels adjacent to each other in a diagonal direction is smaller than a space between the sub-pixels adjacent to each other in the perpendicular direction of the screen.

The present disclosure contains subject matter related to that disclosed in Japanese Priority Patent Application JP 2011-54453 filed in the Japan Patent Office on Mar. 11, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a display section including a plurality of sub-pixels, and displaying a plurality of perspective pictures in a screen; and
an optical separation element optically separating the perspective pictures displayed on the display section, wherein
the sub-pixels are each with, in a planar view, a size in a long-side direction being less than three times a size in a short-side direction.

2. The display device according to claim 1, wherein
the sub-pixels adjacent to each other are different in color in every direction of the screen.

3. The display device according to claim 1, wherein
the sub-pixels each have a hexagonal shape.

4. The display device according to claim 1, wherein
the sub-pixels are in a delta arrangement.

5. The display device according to claim 1, wherein
the optical separation element is
a parallax barrier including a plurality of light pass-through sections allowing light from the display section or light toward the display section to pass therethrough, and a plurality of light block sections allowing the light from the display section or the light toward the display section to be blocked.

6. The display device according to claim 5, wherein
the light pass-through sections and the light block sections in the parallax barrier are each stripe-shaped extending in a perpendicular direction of the screen.

7. The display device according to claim 1, wherein the sub-pixels each have a square shape in a planar view, and a size ratio between the perpendicular and horizontal directions of the screen is 4:3.

8. The display device according to claim 1, wherein
the sub-pixels are in a delta arrangement, and each have a hexagonal shape, and
a space between the sub-pixels adjacent to each other in a diagonal direction is smaller than a space between the sub-pixels adjacent to each other in the perpendicular direction of the screen.

9. A display device comprising:
a display section including a plurality of sub-pixels, and displaying a plurality of perspective pictures in a screen; and
an optical separation element optically separating the perspective pictures displayed on the display section, wherein
the sub-pixels are arranged to have an arrangement pitch in a long-side direction less than three times an arrangement pitch in a short-side direction.

10. The display device according to claim 9, wherein
the sub-pixels adjacent to each other are different in color in every direction of the screen.

11. The display device according to claim 9, wherein
the sub-pixels each have a hexagonal shape.

12. The display device according to claim 9, wherein
the sub-pixels are in a delta arrangement.

13. The display device according to claim 9, wherein
the optical separation element is
a parallax barrier including a plurality of light pass-through sections allowing light from the display section or light toward the display section to pass therethrough, and a plurality of light block sections allowing the light from the display section or the light toward the display section to be blocked.

14. The display device according to claim 13, wherein
the light pass-through sections and the light block sections in the parallax barrier are each stripe-shaped extending in a perpendicular direction of the screen.

15. The display device according to claim 9, wherein the sub-pixels each have a square shape in a planar view, and a size ratio between the perpendicular and horizontal directions of the screen is 4:3.

16. The display device according to claim 9, wherein
the sub-pixels are in a delta arrangement, and each have a hexagonal shape, and
a space between the sub-pixels adjacent to each other in a diagonal direction is smaller than a space between the sub-pixels adjacent to each other in the perpendicular direction of the screen.
